(19) United States
(12) Patent Application Publication
(10) Pub. No.: US 2026/0217089 A1
(43) Pub. Date: Jul. 30, 2026

(54) RETROFITTABLE VENTILATION ASSEMBLY

(71) Applicant: HCL Technologies Limited, New Delhi (IN)

(72) Inventor: R Poorna Chandra Sekar, Chennai (IN)

(21) Appl. No.: 19/460,431

(22) Filed: Jan. 27, 2026

(30) Foreign Application Priority Data
Jan. 27, 2025 (IN) 202511006663

(51) Int. Cl. B60H 1/26

(52) U.S. Cl. CPC B60H 1/267; B60H 1/262

(57) ABSTRACT

A retrofittable ventilation assembly is disclosed. The retrofittable ventilation assembly includes a ventilating surface mounted on at least one window trim of a door, or a sunroof via a plurality of fastening members. Further, the ventilating surface includes an array of perforations formed transversely throughout an outer surface area and an inner surface area of the ventilating surface to allow passage of air therethrough.

### DESCRIPTION

### TECHNICAL FIELD

This disclosure relates generally to the field of a ventilation in vehicles, more particularly to a retrofittable ventilation assembly in vehicles.

### BACKGROUND

During a travelling state, vehicles may encounter inadequate cabin ventilation, particularly when the failure of air-conditioning and not opening a window may be undesirable for an occupant during inclement weather, sandy terrains, etc. Alternatively, opening of the window or operating the air conditioner may result in congestion and discomfort to the occupant, and an influx of dust particles in a cabin. Consequently, inadequate ventilation within the cabin can lead to a suffocating environment for the occupants. As the air within the cabin is neither recirculating nor adequately present, the content of the volatile organic compounds (VOCs) increases, and the oxygen level decreases. Due to this, occupants may experience respiratory difficulties, dizziness, motion sickness, and other related symptoms. Therefore, in such scenarios the air from outside environment is required to be circulated within the cabin.

Accordingly, there is a requirement for a solution to provide ventilation to the occupants in the vehicle in an economically feasible manner without necessitating the design changes of the door.

### SUMMARY

In an embodiment, a retrofittable ventilation assembly is disclosed. The retrofittable ventilation assembly may include a ventilating surface mounted on at least one window trim of a door, or a sunroof via a plurality of fastening members. The ventilating surface may include an array of perforations formed transversely throughout an outer surface area and an inner surface area of the ventilating surface to allow passage of air therethrough.

In another embodiment, a door is disclosed. The door may include a window trim and a retrofittable ventilation assembly mounted on the window trim. The retrofittable ventilation assembly may include a ventilating surface mounted on the window trim via a plurality of fastening members. The ventilating surface may further include an array of perforations formed transversely throughout an outer surface area and an inner surface area of the ventilating surface to allow passage of air therethrough.

In yet another embodiment, a vehicle is disclosed. The vehicle may include a sunroof and at least one door. Each door may include a window trim. The vehicle may include a retrofittable ventilation assembly mounted on the at least one window trim of door and the sunroof. The retrofittable ventilation assembly may include a ventilating surface mounted on the at least one window trim of the door and the sunroof via a plurality of fastening members. The ventilating surface may further include an array of perforations formed transversely throughout an outer surface area and an inner surface area of the ventilating surface to allow passage of air therethrough.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a side view of a door equipped with a retrofittable ventilating assembly, in accordance with an embodiment of the present disclosure.

FIG. 2 illustrates a perspective view of a ventilating surface, in accordance with an embodiment of the present disclosure.

FIG. 3 illustrates another perspective view of the ventilating surface, in accordance with an embodiment of the present disclosure.

FIG. 4 illustrates a front view of a window trim equipped with the ventilating surface, in accordance with an embodiment of the present disclosure.

FIG. 5 illustrates a side-sectional view of the ventilating surface, in accordance with an embodiment of the present disclosure.

FIG. 6 illustrates a front view of the ventilating surface and the window trim, in accordance with an embodiment of the present disclosure.

FIG. 7 illustrates a front view of an upper portion of a periphery, in accordance with an alternative embodiment of the present disclosure.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constru7ctions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusions, such that a system or a device that comprises a list of components or steps does not include only those components or steps but may include other components or steps not expressly listed or inherent to such setup or device. In other words, one or more elements in a system or apparatus proceeded by “comprises… a” does not, without more constraints, preclude the existence of other elements or additional elements in the system or apparatus.

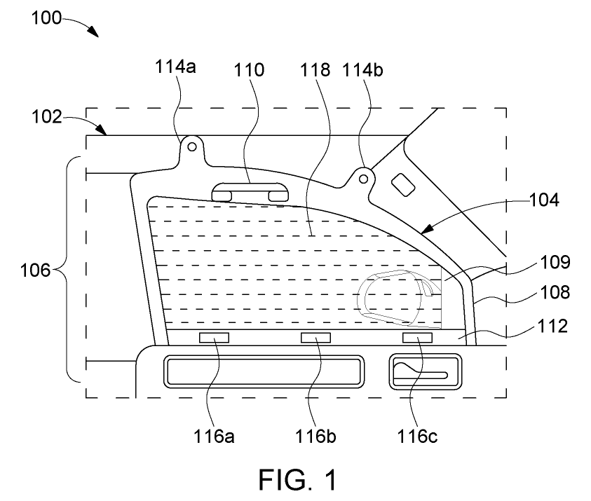

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-7. It is to be noted that the system may be employed in any vehicle including but not limited to a passenger vehicle, a utility vehicle, heavy commercial vehicles, and any other transportable machinery. For the sake of clarity, the vehicle is not shown.

As explained earlier, in the non-operational state of the air-conditioning and in the closed state of the window, there may be no air circulation in the cabin. Therefore, there exists a vital need for controlled ventilation i.e., circulation of air in the cabin in order to provide comfort to the occupant.

Therefore, to allow air from outside to pass therethrough in a controlled manner, a retrofittable ventilating assembly is disclosed. The retrofittable ventilating assembly may be mounted on a window trim of a vehicle door of the vehicle. The retrofittable ventilating assembly may be conveniently attachable and detachable from the window trim by an occupant.

Referring to FIG. 1, a side view of a door 102 equipped with a retrofittable ventilating assembly 104 is illustrated, in accordance with an embodiment of the present disclosure. In an embodiment, the door 102 may include a window trim 106 formed in a periphery of a window of a vehicle. As the name suggests, the retrofittable ventilation assembly 104 may be retrofitted on the window trim 106 of the door 102. Example of the vehicle may include, light motor vehicle, heavy motor vehicle, medium goods vehicle, light goods vehicles, and the like. By way of example, the retrofittable ventilation assembly 104 may also be mounted and retrofitted to a sunroof (not shown in FIG.) of the vehicle. The retrofittable ventilation assembly 104 may be retrofitted when a window-pane (not shown in FIG.) may be rolled down to allow the air passage therethrough.

The retrofittable ventilation assembly 104 may include a ventilating surface 108 mounted on the window trim 106 via a plurality of fastening members (not shown). It is to be noted, the ventilating surface 108 may be formed corresponding to a shape and dimensions of the window trim 106. The ventilating surface 108 may be a transparent plastic material formed for ease of visibility and ductility. Examples of transparent plastic material may include, polycarbonate, acrylic, polyethylene terephthalate (PET), and the like.

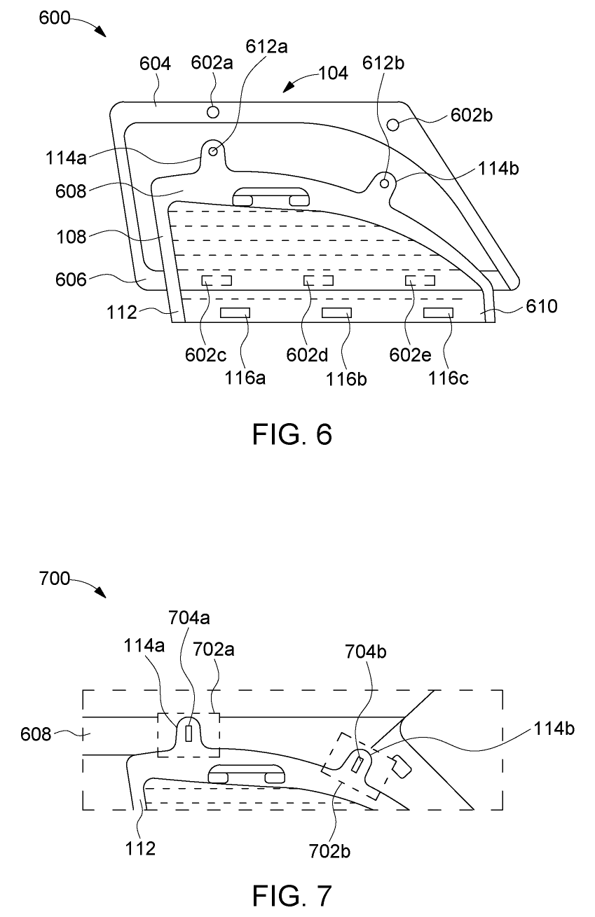

The ventilating surface 108 may include an outer surface area (not shown in FIG.) and an inner surface area 109. When retrofitted, the inner surface area 109 may face a cabin of the vehicle and the outer surface area may be facing the surroundings. The inner surface area 109 may include a handle 110. The handle 110 may be configured to mount the retrofittable ventilation assembly 104 on the window trims of the door 102 and the sunroof. Further, the handle 110 may provide support to the occupant. The ventilating surface 108 may include a periphery 112. The periphery 112 may include a pair of protrusions 114a, 114b and a plurality of mounting profiles 116a, 116b, and 116c formed corresponding to the configuration of the plurality of fastening members adjoined to the window trim 106. This is explained in greater details in conjunction with FIG. 6 and 7.

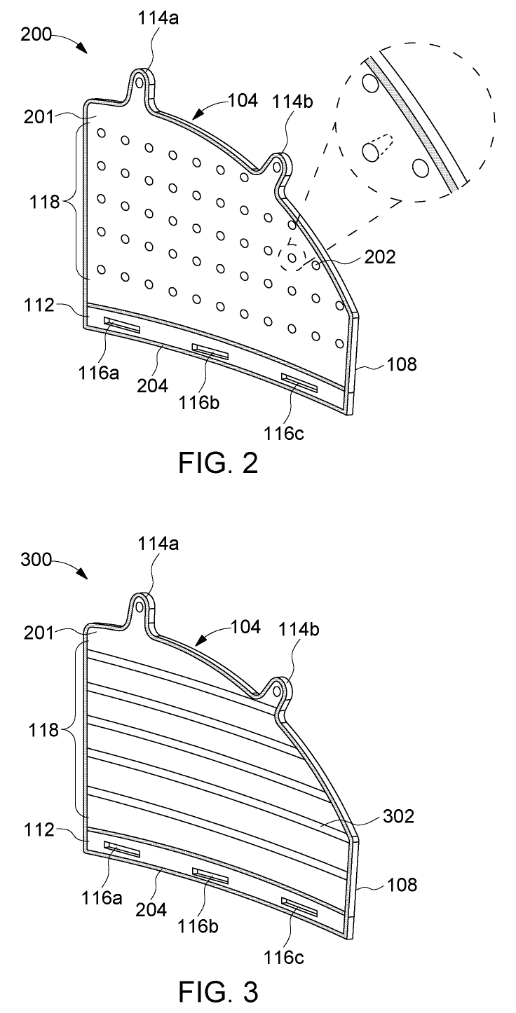

The ventilating surface 108 may include an array of perforations 118 formed transversely throughout the outer surface area and the inner surface area 109 of the ventilating surface 108 to allow passage of air therethrough. Each perforation 118 may include at least one of a linear array of grooves (not shown in FIG.) formed between the outer surface area and the inner surface area 109, or a slit (not shown in FIG. 2) formed between the outer surface area and the inner surface area 109, or a combination thereof. This is explained in greater detail in conjunction with FIGS. 2-5.

FIG. 2 illustrates a perspective view 200 of the ventilating surface 108, in accordance with an embodiment of the present disclosure. FIG. 2 depicts an outer surface area 201 of the ventilating surface 108. As explained earlier, the ventilating surface 108 may include the pair of protrusions 114a, 114b and the plurality of mounting profiles 116a, 116b, and 116c. The pair of protrusions 114a, 114b and the plurality of mounting profiles 116a, 116b, and 116c may be disposed on the periphery 112 of the ventilating surface 108. In another example, the pair of protrusions 114a, 114b and the plurality of mounting profiles 116a, 116b, and 116c may be extruded from the periphery 112 of the ventilating surface 108. Further, the pair of protrusions 114a, 114 may be disposed opposite to each other. Further, the ventilating surface 108 may include the array of perforations 118 formed transversely throughout the outer surface area 201 and the inner surface area 109 of the ventilating surface 108. Each perforation 118 may include at least one of a linear array of grooves 202 or a slit (not shown in FIG. 2), or a combination thereof, formed between the outer surface area 201 and the inner surface area 109. The linear array of grooves 202 may be utilized to allow the passage of air therethrough when the vehicle may be in a transient state i.e., in motion.

For example, when the vehicle may be in a transient state and the ventilating surface 108 may be mounted on the window trim 106. The air may pass through each perforation118 i.e., the linear array of grooves 202. Each groove 202 may be transversely formed throughout the inner surface area 109 and the outer surface area 201. Each groove 202 may be separated by a predefined gap from the sequential groove 202. Moreover, each groove 202 may be transversely shaped relative to the outer surface area 201 by a predefined angle “θ”. The predefined angle may range from about 20° to about 40°. Particularly, each groove 202 may converge and inclined towards the inner surface area 109. Therefore, a maximum influx of air and least amount of dust and dirt influx into the cabin may be achieved.

Further, when the vehicle speed is beyond a predefined threshold the vibrations may occur on the ventilating surface 108. Therefore, the ventilating surface 108 may include a dampening member 204 adjoined to the periphery 112 and configured to damp vibrations caused by the passage of air. Further, the damping member 204 may be configured to secure the window trim 106, allowing no passage of the air from the perimeter.

FIG. 3 illustrates another perspective view 300 of the ventilating surface 108, in accordance with an embodiment of the present disclosure. The retrofittable ventilating assembly 104 may include a perforation such as a slit 302 formed between the outer surface area 201 and the inner surface area 109. Each slit 302 may be a continuous horizontal groove formed between the outer surface area 201 and the inner surface area 109 to allow passage of air therethrough. Further, each slit 302 may be inclined inwards or transverse i.e., in the predefined angle, with respect to the outer surface area 201 of the ventilating surface 108. Therefore, the air may descend along the predefined angle of the linear groove 202 and the slit 302 and enter the cabin. Accordingly, in the transient state of the vehicle, the passage of air may possess efficient transmittivity by virtue of transverse geometry of each groove and the slit. Accordingly, the air flow may be optimized for enhanced ventilation.

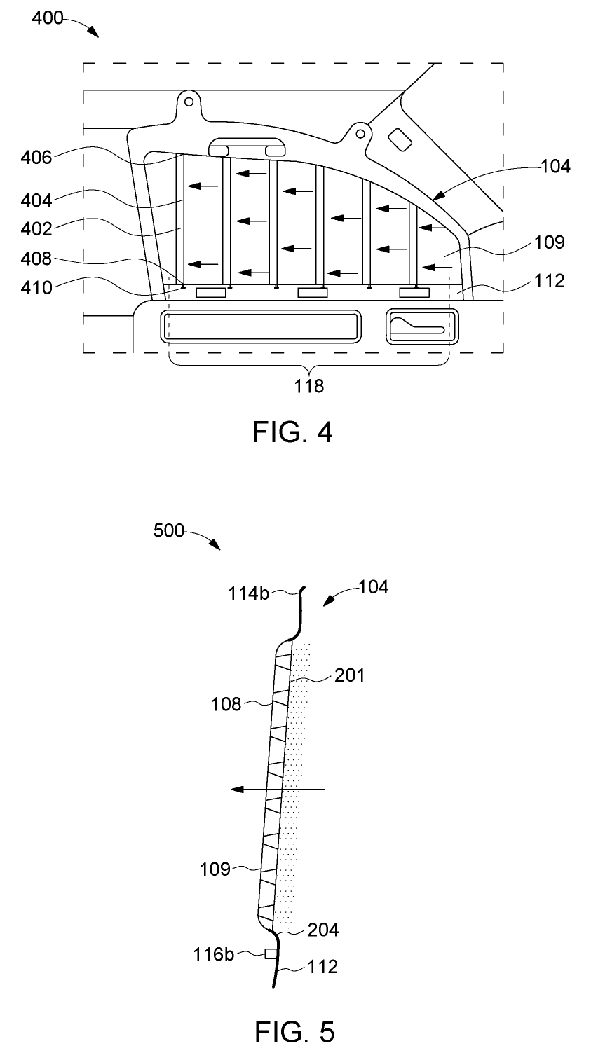

FIG. 4 illustrates a front view 400 of the window trim 106 equipped with the ventilating surface 108, in accordance with an embodiment of the present disclosure. FIG. 4 depicts each perforation may include a vertical slit 402 formed between the outer surface area 201 and the inner surface area 109. In another example, the vertical slit 402 may be adopted in rainy weather. The vertical slit 402 may be a continuous groove configured to restrict passage of rain drops and allow passage of air therethrough. Each vertical slit 402 may include a strip 404 formed corresponding thereto. Each strip 404 may include an upper end 406 and a lower end 408 disposed opposite to the upper end 406. The lower end 408 may include a knob 410 configured to adjust an opening angle of the vertical slit 402. In another example, the knob 410 may be coupled to the upper end 406. The knob 410 may be rotated in a counter-clock direction to tilt the strip 404 inwards, thereby restricting the entrance of rain and allowing controlled air circulation in the cabin.

FIG. 5 illustrates a side-sectional view 500 of the ventilating surface 108, in accordance with an embodiment of the present disclosure. FIG. 5 depicts the air flowing from the ventilating surface 108 in the controlled manner. As apparent from FIG. 5, the air may be flowing from the outer surface area 201 to the inner surface area 109. The air may flow via the array of perforations 118. Further, the ventilating surface 108 may be sealed from the periphery 112 via the damping member 204.

FIG. 6 illustrates a front view 600 of the ventilating surface 108 and window trim 106, in accordance with an embodiment of the present disclosure. FIG. 6 depicts the engagement between the plurality of mounting profiles 116a, 116b, and 116c and a plurality of fastening members 602a, 602b, 602c, 602d, and 602e (collectively referred to as the fastening members 602) adjoined to the window trim 106.

In an embodiment, the window trim 106 may include an upper trim 604 and a lower trim 606 disposed opposite to the upper trim 604. The upper trim 604 and lower trim 606 may include the fastening members 602. Particularly, the fastening members 602a, 602b may be adjoined to the upper trim 604 and the fastening members 602c, 602d, and 602e may be adjoined to the lower trim 606. Examples of the plurality of fastening members 602 may include, snap-fit joints, press-fit joint, and the like. In another example, the fastening members 602c, 602d, and 602e may be U-shaped fasteners, j-shaped fasteners, and the like. The plurality of fastening members 602 may be configured to enable retrofitting of the ventilating surface 108 with the window trim 106 without requiring skills and efforts.

As explained earlier, the ventilating surface 108 may include the periphery 112. The periphery 112 may be indented and formed corresponding to the window trim 106. The periphery 112 may be configured to adjoin the ventilating surface 108 to the window trim 106. The periphery 112 may include an upper portion 608 and a lower portion 610 disposed opposite to the upper portion 608. The upper portion 608 may be formed in a slanting curved configuration, and may include the pair of protrusions 114a, 114b. Each protrusion 114a, 114b may be disposed opposite to each other. The protrusion 114bmay be tilted by an angle ranging from about 30° to about 40° from the slanted curved configuration of the upper portion 608. Each protrusion 114a, 114b may include a slot 612a, 612b. The slot 612a, 612b may be engaged to the corresponding fastening members 602a, 602b. By way of example, in case of snap fit joints, each fastening member 602a, 602b may be a pin adjoined to the upper trim 604. The pin may be fitted in the corresponding slot 612a, 612b to form a fasting connection therebetween. Thus, the upper portion 608 may be engaged with the upper trim 604.

Further, the lower portion 610 may be curved, and may include the plurality of mounting profiles 116a, 116b, and 116c. The mounting profiles 116a, 116b, and 116c may be formed corresponding to the fastening members 602c, 602d, and 602e. Further, the mounting profiles 116a, 116b, and 116c may be configured to engage the fastening members 602c, 602d, and 602e to fasten the ventilating surface 108 to the window trim 106. Thus, the lower portion 610 may be engaged with the lower trim 606. Each slot 612a, 612b and the mounting profiles 116a, 116b, 116c may be engaged to the corresponding fastening members 602. Such engagement therebetween may act as a lock, i.e., locking the ventilation surface 108 with the window trim 106.

In another example, the pair of protrusions 114a, 114b and the plurality of mounting profiles 116a, 116b, 116c may be engaged to a plurality of indents (not shown in FIG.) formed on the window trim 106 of the door 102. Therefore, the ventilating surface 108 may be securely retrofitted to the window trim 106.

FIG. 7 illustrates a front view of the upper portion 208 of the periphery 112, in accordance with an alternative embodiment of the present disclosure. FIG. 7 is explained in conjunction with the FIG. 6. As explained earlier, the upper portion 208 may include the pair of protrusions 114a, 114b. In an alternative embodiment, each protrusion 114a, 114b may include a seam plate 702a, 702b welded thereto. Further, each protrusion 114a, 114b may include a hook bolt 704a, 704b, and configured to engage with the fastening members 602a, 602b. By way of example, the hook bolt 704a, 704b may be a threaded bolt. Further, the fastening member 602a, 602b may include, but not limited to a nut, a threaded receptacle, and the like, formed corresponding to a thread of the threaded bolt. The hook bolt 704a, 704b, particularly the thread of the hook bolt 704a, 704b may be configured to be engaged with the threaded bolt of the fastening members 602a, 602b, thus, retrofitting the ventilating surface 108 to the window trim 106.

As will be appreciated by those skilled in the art, the retrofittable ventilation assembly described in the various embodiments discussed above are not routine, or conventional or well understood in the art. The retrofittable ventilation assembly discussed above may be capable of offering several advantages. Firstly, the retrofittable ventilation assembly allows passage of air therethrough. The air may pass through the transversely formed array of perforations on the ventilating surface, and prevents dust particles into the cabin.

Secondly, the assembly is easily assembled and removed from the window trim without utilization of skills based on the needs of the occupant. This is possible due to the plurality of mounting profiles formed corresponding to the plurality of fastening members adjoined on the window trim. Furthermore, there may be no need to make excessive modifications in the door for retrofitting of the retrofittable ventilation assembly. Accordingly, the simple assembly of allowing the air passage offers cost savings to the manufacturer and customer. The retrofittable ventilation assembly is economical in manufacturing, selling, buying, and utilization. Also, the assembly may be easily incorporated into upcoming vehicles and existing vehicles with minor modifications.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A retrofittable ventilation assembly, comprising:
a ventilating surface mounted on at least one of a window trim of a door, or a sunroof via a plurality of fastening members, wherein the ventilating surface comprises:
an array of perforations formed transversely throughout an outer surface area and an inner surface area of the ventilating surface to allow passage of air therethrough.

2. The retrofittable ventilation assembly of claim 1, wherein each perforated portion comprises at least one of:
a linear array of grooves formed between the outer surface area and the inner surface area, and/or
a slit formed between the outer surface area and the inner surface area.

3. The retrofittable ventilation assembly of claim 1, wherein the ventilating surface comprises:
a periphery comprising:
a plurality of mounting profiles formed corresponding to the plurality of fastening members adjoined to the window trim,
wherein the plurality of mounting profiles are configured to engage the plurality of fastening members to fasten the ventilating surface to the window trim.

4. The retrofittable ventilation assembly of claim 3, wherein the ventilating surface comprises:
a dampening member adjoined to the periphery and configured to damp vibrations caused by the passage of air.

5. A door, comprising:
a window trim; and
a retrofittable ventilation assembly mounted on the window trim, the retrofittable ventilation assembly comprising:
a ventilating surface mounted on the window trim via a plurality of fastening members, wherein the ventilating surface comprises:
an array of perforations formed transversely throughout an outer surface area and an inner surface area of the ventilating surface to allow passage of air therethrough.

6. The door of claim 5, wherein each perforated portion comprises at least one of:
a linear array of grooves formed between the outer surface area and the inner surface area, and/or
a slit formed between the outer surface area and the inner surface area.

7. The door of claim 5, wherein the ventilating surface comprises:
a periphery comprising:
a plurality of mounting profiles formed corresponding to the plurality of fastening members adjoined to the window trim,
wherein the plurality of mounting profiles are configured to engage the plurality of fastening members to fasten the ventilating surface to the window trim.

8. The door of claim 6, wherein the ventilating surface comprises:
a dampening member adjoined to the periphery and configured to damp vibrations caused by the passage of air.

9. A vehicle, comprising:
a sunroof;
at least one door, wherein each door comprises:
a window trim; and
a retrofittable ventilation assembly mounted on the at least one window trim of the door and the sunroof, the retrofittable ventilation assembly comprising:
a ventilating surface mounted on the at least one window trim of the door, or the sunroof via a plurality of fastening members, wherein the ventilating surface comprises:
an array of perforations formed transversely throughout an outer surface area and an inner surface area of the ventilating surface to allow passage of air therethrough.

10. The vehicle of claim 9, wherein each perforated portion comprises at least one of:
a linear array of grooves formed between the outer surface area and the inner surface area, and/or
a slit formed between the outer surface area and the inner surface area.

11. The vehicle of claim 9, wherein the ventilating surface comprises:
a periphery comprising:
a plurality of mounting profiles formed corresponding to the plurality of fastening members adjoined to the window trim,
wherein the plurality of mounting profiles are configured to engage the plurality of fastening members to fasten the ventilating surface to the window trim.

12. The vehicle of claim 11, wherein the ventilating surface comprises:
a dampening member adjoined to the periphery and configured to damp vibrations caused by the passage of air.
